(19) United States
(12) Patent Application Publication
(10) Pub. No.: US 2024/0151264 A1
(43) Pub. Date: May 9, 2024

(54) WHEEL BEARING DEVICE

(71) Applicant: NTN CORPORATION, Osaka (JP)

(72) Inventors: Masashi FUNAHASHI, Shizuoka (JP); Teruaki FUJIO, Shizuoka (JP); Masaya INOUE, Shizuoka (JP)

(21) Appl. No.: 18/282,352

(22) PCT Filed: Mar. 14, 2022
(86) PCT No.: PCT/JP2022/011292

§ 371 Date: Sep. 15, 2023

(30) Foreign Application Priority Data
Mar. 25, 2021 (JP) 2021-052147

(51) Int. Cl. F16C 19/18; F16D 1/02; F16D 3/16

(52) U.S. Cl. CPC F16C 19/183; F16D 1/02; F16D 3/16; B60B 27/0094

(57) ABSTRACT

An outer joint member 31 and a hub wheel 16 are coupled so as to be able to transmit torque by meshing face splines 51 and 52 respectively provided and applying a tightening force in an axial direction between both the face splines 51 and 52. Shapes of tooth surfaces of both the face splines 51 and 52 are determined such that, in a process of bringing both the face splines 51 and 52 close to each other in the axial direction and meshing with each other, tooth surfaces 51a and 51b of both the face splines 51 and 52 first come into contact with each other in, among an outer diameter portion Ea of a meshing region X between both the face splines, an inner diameter portion Ec, and an intermediate portion Eb sandwiched between the outer diameter portion and the inner diameter portion, the intermediate portion Eb.

### TECHNICAL FIELD

The present invention relates to a wheel bearing device for rotatably supporting a wheel with respect to a vehicle body in a vehicle such as an automobile.

### BACKGROUND ART

As a wheel bearing device in which a double-row rolling bearing (wheel bearing) and a constant velocity universal joint are unitized, there is known a bearing device in which torque is transmitted between a hub wheel and an outer joint member of the constant velocity universal joint via face splines respectively provided on an end surface of the hub wheel and an end surface of the outer joint member (FIG. 7 of the Patent Literature 1). In this wheel bearing device, the outer joint member and the hub wheel are coupled by inserting a bolt member through the hub wheel and screwing the bolt member into a screw hole provided in a bottom portion of a bowl-shaped part of the outer joint member in a state in which the seat surface of the bolt member is engaged with the end surface of the hub wheel.

In a wheel bearing device using face splines as described above, there are known: a bearing device in which, when the face splines are meshed with each other, teeth of both the face splines are first brought into contact with each other on the radially outer side, and the teeth are brought into contact with each other even on the radially inner side as tightening is strengthened (Patent Literature 2); and a bearing device in which the teeth are first brought into contact with each other on the radially inner side, and the teeth are brought into contact with each other even on the radially outer side as tightening is strengthened (Patent Literature 3).

### CITATIONS LIST

### Patent Literature

Patent Literature 1: JP 2009-115292 A
Patent Literature 2: JP 5039048 B2
Patent Literature 3: US 2015/0,021,973 A

### SUMMARY OF INVENTION

### Technical Problems

Patent Literature 2 describes that a first tooth and a second tooth come into contact with each other over the entire length of tooth surfaces of both the teeth when both the teeth reach almost 75% of a normal tightening force (Paragraph 0028). However, a machining error cannot be avoided during machining of the face spline, and thus the shape of the tooth surface cannot be manufactured as ideal. Therefore, it may be theoretically possible, but is practically difficult to bring the tooth surfaces into contact with each other over the entire radial length of the tooth surfaces of both the teeth after a predetermined tightening force is applied, and the tooth surfaces of both the face splines can be brought into contact with each other only in a part of a meshing region.

When the face splines are meshed with each other, a portion that comes into contact with the mating side in the first half of the meshing work is often a contact region between the tooth surfaces at the time of torque transmission. Therefore, after the tightening force is applied, in the configuration of Patent Literature 2, the outer diameter side of the meshing region, in the radial direction, between the tooth surfaces is mainly the contact region between the tooth surfaces, while in the configuration of Patent Literature 3, the inner diameter side is mainly the contact region between the tooth surfaces.

When torque is transmitted in a state in which the constant velocity universal joint of the wheel bearing device has an operating angle, a bending moment repeatedly acts on a connecting portion between the outer joint member of the constant velocity universal joint and the hub wheel. Therefore, in a case where the contact region between the tooth surfaces exists on the outer diameter side as in Patent Literature 2, the tooth surfaces are not in contact with each other on the outer diameter side of the meshing region between the face splines through the deformation of the bolt member in a partial region in the circumferential direction of the meshing region (a region that is convexly bent when the bending moment is applied). As a result, the area of the contact region in the meshing region greatly decreases, and thus the meshing between the face splines may be released. In particular, in the meshing region between the face splines, a component force Fa, in the direction along the tooth surface of a torque transmission force F acting between tooth surfaces 151a and 152a, acts in the direction of releasing the meshing between the teeth during torque transmission, as illustrated in FIG. 10, and thus the meshing between the face splines is more likely to be released. Therefore, in the configuration of Patent Literature 2, there is a problem that the bending rigidity of the wheel bearing device decreases.

On the other hand, in the configuration in which the contact region between the tooth surfaces during torque transmission is on the inner diameter side, as in Patent Literature 3, there is no contact region on the outer diameter side, so that the influence of the bending moment on the bending rigidity of the wheel bearing device is reduced. However, the rotation radius of the contact region is small, and thus the load capacity at the time of torque transmission decreases, and there is a problem that it is difficult to transmit high torque.

In view of the above, an object of the present invention is to provide a wheel bearing device that has high bending rigidity and can increase a load capacity at the time of torque transmission.

### Solutions to Problems

The present invention provides a wheel bearing device including: a wheel bearing including an inner member having double row inner raceway surfaces and a flange portion for being attached to a wheel, an outer member having double row outer raceway surfaces, and a plurality of rolling elements disposed between the inner raceway surfaces and the outer raceway surfaces facing each other; and a constant velocity universal joint having an outer joint member, the outer joint member and the inner member being coupled so as to be able to transmit torque by meshing face splines respectively provided in the outer joint member and the inner member and applying a tightening force in an axial direction between both the face splines, in which shapes of tooth surfaces of both the face splines are determined such that, in a process of bringing both the face splines close to each other in the axial direction and meshing with each other, the tooth surfaces of both the face splines first come into contact with each other in, among an outer diameter portion of a meshing region between both the face splines, an inner diameter portion, and an intermediate portion sandwiched between the outer diameter portion and the inner diameter portion, the intermediate portion.

In the process of bringing both the face splines close to each other in the axial direction and meshing with each other, in a region where the tooth surfaces come into contact with each other in the early stage, both the tooth surfaces are elastically deformed as the meshing progresses, and the contact state is maintained. Therefore, the region where the tooth surfaces come into contact with each other in the early stage is a contact region where the tooth surfaces are in contact with each other during torque transmission even if there is a slight machining error in the tooth surfaces. According to the above configuration, the contact region between both the tooth surfaces is formed in at least the intermediate portion, so that a bending moment acts due to torque transmission by the constant velocity universal joint having an operating angle, and thus the meshing between both the face splines is likely to be released on the outer diameter side, while, in the intermediate portion, the contact region between both the tooth surfaces is maintained. Therefore, the meshing between both the face splines is not released. When the contact region between both the tooth surfaces exists in the intermediate portion, the rotation radius of the contact region is generally increased, so that it is possible to sufficiently secure the load capacity at the time of torque transmission.

In such a configuration, it is preferable to determine the shapes of the tooth surfaces of both the face splines such that the tooth surfaces of both the face splines come into contact with each other in the outer diameter portion following the intermediate portion. As a result, the contact region between both the tooth surfaces during torque transmission expands in the radially outward direction, so that the load capacity at the time of torque transmission can be further increased.

It is preferable that, assuming that, of the meshing region between both the face splines, an inner diameter end of a tooth crest of one of the face splines is 0% and an outer diameter end is 100%, a region of 50% to 90% is defined as the intermediate portion.

When a region of 50% or more of the tooth crest is defined as the intermediate portion in this way, the contact region between both the tooth surfaces during torque transmission is formed on the outer diameter side, so that the load capacity at the time of torque transmission can be further increased.

### Advantageous Effects of Invention

According to the present invention, it is possible to provide a wheel bearing device having high bending rigidity and capable of increasing the load capacity at the time of torque transmission, as described above.

### BRIEF DESCRIPTION OF DRAWINGS

FIG. 1 is a cross-sectional view of a wheel bearing device as viewed in a cross section along an axial direction.

FIG. 2 is a front view of an outer joint member as viewed from an outboard side.

FIG. 3 is a cross-sectional view illustrating, in the wheel bearing device illustrated in FIG. 1, a process of bringing face splines close to each other in the axial direction and meshing with each other.

FIG. 4 is cross-sectional views of a meshing region between face splines as viewed in a cross section along a circumferential direction.

FIG. 5 is a front view of the meshing region between the face splines as viewed from the axial direction.

FIG. 6A is a cross-sectional view illustrating, in an enlarged manner, a first face spline of the wheel bearing device illustrated in FIG. 1.

FIG. 6B is a cross-sectional view illustrating, in an enlarged manner, the first face spline of the wheel bearing device illustrated in FIG. 1.

FIG. 7A is a cross-sectional view illustrating, in an enlarged manner, the first face spline of the wheel bearing device illustrated in FIG. 1.

FIG. 7B is a cross-sectional view illustrating, in an enlarged manner, the first face spline of the wheel bearing device illustrated in FIG. 1.

FIG. 8A is a cross-sectional view illustrating, in an enlarged manner, the first face spline of the wheel bearing device illustrated in FIG. 1.

FIG. 8B is a cross-sectional view illustrating, in an enlarged manner, the first face spline of the wheel bearing device illustrated in FIG. 1.

FIG. 9A is a cross-sectional view illustrating, in an enlarged manner, the first face spline of the wheel bearing device illustrated in FIG. 1.

FIG. 9B is a cross-sectional view illustrating, in an enlarged manner, the first face spline of the wheel bearing device illustrated in FIG. 1.

FIG. 10 is a cross-sectional view of a meshing region between face splines as viewed in a cross section along the circumferential direction.

### DESCRIPTION OF EMBODIMENTS

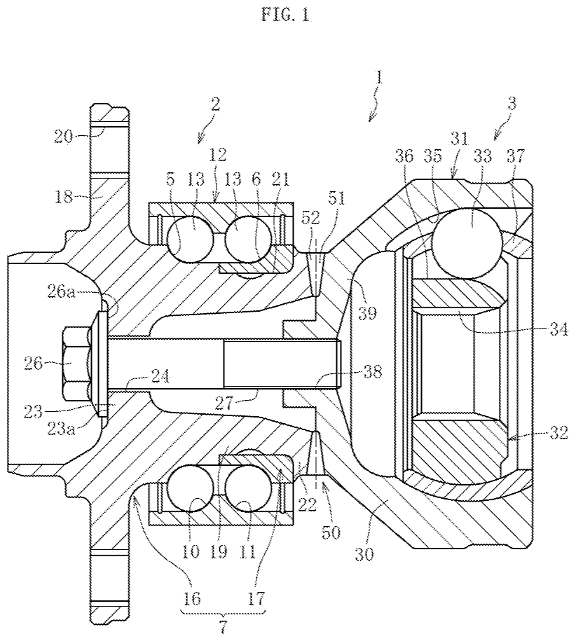

Hereinafter, a wheel bearing device according to an embodiment of the present invention will be described with reference to FIGS. 1 to 9A and 9B. In the following description, a direction outside in a vehicle width direction when attached to a vehicle body is referred to as an outboard side, and a direction inside in the vehicle width direction is referred to as an inboard side.

As illustrated in FIG. 1, a wheel bearing device 1 according to this embodiment has a structure in which a wheel bearing 2 and a constant velocity universal joint 3 are unitized.

The wheel bearing 2 mainly includes an inner member 7 having double row inner raceway surfaces 5 and 6, an outer member 12 disposed on the outer diameter side of the inner member 7 and having double row outer raceway surfaces 10 and 11, a plurality of rolling elements 13 disposed between the radially facing inner raceway surfaces 5 and 6 and outer raceway surfaces 10 and 11, and a cage (not illustrated) for holding the rolling elements 13 at equal intervals in a circumferential direction.

The inner member 7 has a hub wheel 16 and an inner ring 17 fixed to the outer periphery of the hub wheel 16. One inner raceway surface 5 of the double row inner raceway surfaces 5 and 6 is formed on the outer peripheral surface of the hub wheel 16, and the other inner raceway surface 6 is formed on the outer peripheral surface of the inner ring 17.

The hub wheel 16 includes a flange portion 18 to be attached to a wheel of a vehicle and a cylindrical portion 19 having a cylindrical shape. A bolt mounting hole 20 is provided in the flange portion 18 of the hub wheel 16. A hub bolt for fixing the wheel and a brake rotor to the flange portion 18 is fixed to the bolt mounting hole 20. A small diameter portion 21 is formed at an inboard-side end portion of the cylindrical portion 19, and the inner ring 17 is press-fitted and fixed to an outer peripheral surface of the small diameter portion 21. A fastening part 22, plastically deformed to the outer diameter side by fastening after being press-fitted into the small diameter portion 21 of the inner ring 17, is formed at an inboard-side end portion of the cylindrical portion 19 of the hub wheel 16. The fastening part 22 is in close contact with an inboard-side end surface of the inner ring 17. The inner ring 17 is positioned by the fastening part 22, and a predetermined preload is applied to the inside of the wheel bearing 2. An inner wall part 23 protruding to the inner diameter side is provided on the inner peripheral surface, on the outboard side, of the cylindrical portion 19 of the hub wheel 16. The inner wall part 23 has a through hole 24 in the axial direction on the axial center thereof. A bolt member 26 is inserted into the through hole 24 from the outboard side.

The constant velocity universal joint 3 is constituted by a fixed type constant velocity universal joint that allows only angular displacement and does not allow axial displacement. The constant velocity universal joint 3 mainly includes an outer joint member 31 having a cup-shaped mouth part 30, an inner joint member 32 housed on the inner diameter side of the mouth part 30 of the outer joint member 31, and a ball 33 as a torque transmission member disposed between the inner joint member 32 and the outer joint member 31. A female spline 34 is formed on an inner peripheral surface of the center hole of the inner joint member 32, and a male spline formed at an end portion of a non-illustrated intermediate shaft is inserted into the female spline 34. As a result, the inner joint member 32 and the intermediate shaft are coupled so as to be able to transmit torque.

Track grooves 35 extending in the axial direction are formed at a plurality of positions, in the circumferential direction, of the spherical inner peripheral surface of the mouth part 30, and track grooves 36 extending in the axial direction are formed at a plurality of positions, in the circumferential direction, of the spherical outer peripheral surface of the inner joint member 32. The track groove 35 of the outer joint member 31 and the track groove 36 of the inner joint member 32, which face each other in the radial direction, form a pair, and one ball 33 is rollably incorporated in each of a plurality of ball tracks formed by the respective pairs of the track grooves 35 and 36. The respective balls 33 are held at equal positions in the circumferential direction by a cage 37. The spherical outer peripheral surface of the cage 37 is in contact with the spherical inner peripheral surface of the outer joint member 31, and the spherical inner peripheral surface of the cage 37 is in contact with the spherical outer peripheral surface of the inner joint member 32.

In FIG. 1, the groove bottom of the track groove 35 of the outer joint member 31 is formed in a linear shape at an opening-side end portion of the mouth part 30, and the groove bottom of the track groove 36 of the inner joint member 32 is formed in a linear shape at a back-side end portion of the mouth part 30 (undercut free type). However, the entire groove bottoms of both the track grooves 35 of the outer joint member 31 and the track grooves 36 of the inner joint member 32 can be formed in a curved shape.

When an operating angle is imparted between the outer joint member 31 and the inner joint member 32, the ball 33 held in the cage 37 is always maintained, at any operating angle, within a bisecting plane of the operating angle. As a result, constant velocity between the outer joint member 31 and the inner joint member 32 can be secured. Rotational torque is transmitted between the outer joint member 31 and the inner joint member 32 via the balls 33 in a state in which constant velocity is secured.

The mouth part 30 has a bottom 39 in which a female screw part 38 centered on the axis is formed. When a male screw part 27 formed at the tip of the bolt member 26 is screwed into the female screw part 38, a seat surface 26a of the bolt member 26 is axially engaged with an outboard-side end surface 23a of the inner wall part 23. When the bolt member 26 is further screwed, a tightening force is applied between the outer joint member 31 and the hub wheel 16 in the axial direction that is a direction of bringing the two close to each other.

A torque transmission part 50 is provided between the inner member 7 of the wheel bearing 2 and the bottom 39 of the mouth part 30 of the outer joint member 31. The torque transmission part 50 is formed by fitting a first face spline 51 formed on the joint 3 side and a second face spline 52 formed on the bearing 2 side.

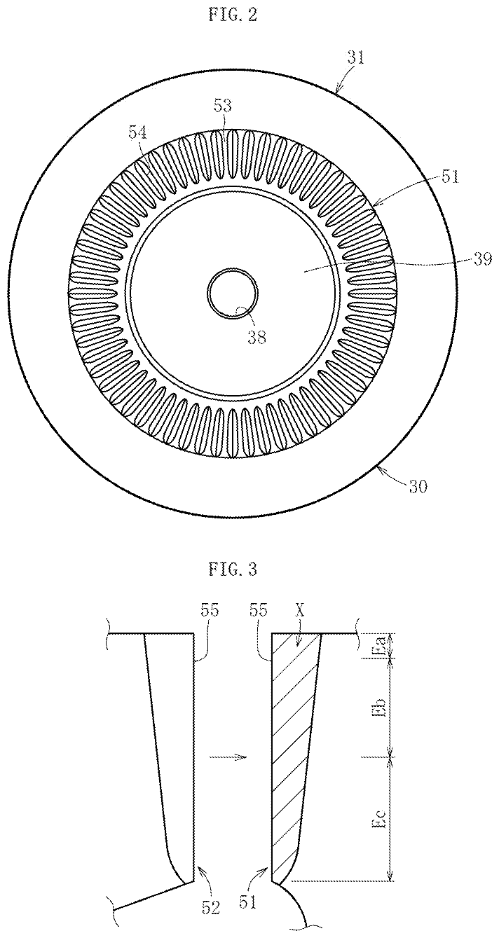

In the present embodiment, the first face spline 51 is formed on the outboard-side end surface of the bottom 39 of the mouth part 30, while the second face spline 52 is formed on the inboard-side end surface of the fastening part 22 of the hub wheel 16. FIG. 2 is a view of the first face spline 51 as viewed from the axial direction. As illustrated in FIG. 2, the first face spline 51 has a form in which a plurality of radially-extending ridges 53 and a plurality of radially-extending recesses 54 are alternately arranged in the circumferential direction. Although not illustrated, the second face spline 52 also has a form in which a plurality of radially-extending ridges and a plurality of radially-extending recesses are alternately arranged in the circumferential direction, similarly to the first face spline 51. When the first face spline 51 and the second face spline 52 are meshed with each other and when a tightening force in the axial direction is further applied between both the face splines 51 and 52 by screwing the bolt member 26 into the female screw part 38, the outer joint member 31 and the hub wheel 16 are coupled so as to be able to transmit torque.

When the first face spline 51 and the second face spline 52 are meshed with each other, both the face splines 51 and 52 are brought close to each other in the axial direction under the action of the tightening force by the bolt member 26 (see FIG. 1), as illustrated in FIG. 3. A hatched region in FIG. 3 represents a meshing region X where the ridges of one of the face splines and the recesses of the other of the face splines finally mesh with each other. Hereinafter, of the meshing region X, a plane 55 including the tooth tip of each ridge provided in one of the face splines is referred to as a “tooth crest”, a region including the outer diameter end of the tooth crest 55 of the meshing region X is referred to as an outer diameter portion Ea, a region including the inner diameter end of the tooth crest 55 of the meshing region X is referred to as an inner diameter portion Ec, and a region sandwiched between the outer diameter portion Ea and the inner diameter portion Ec is referred to as an intermediate portion Eb.

In the present embodiment, the shape of each of the tooth surfaces of both the face splines 51 and 52 is determined such that, in the process of bringing the first face spline 51 and the second face spline 52 close to each other in the axial direction and meshing with each other, the tooth surfaces of both the face splines 51 and 52 first come into contact with each other in the intermediate portion Eb.

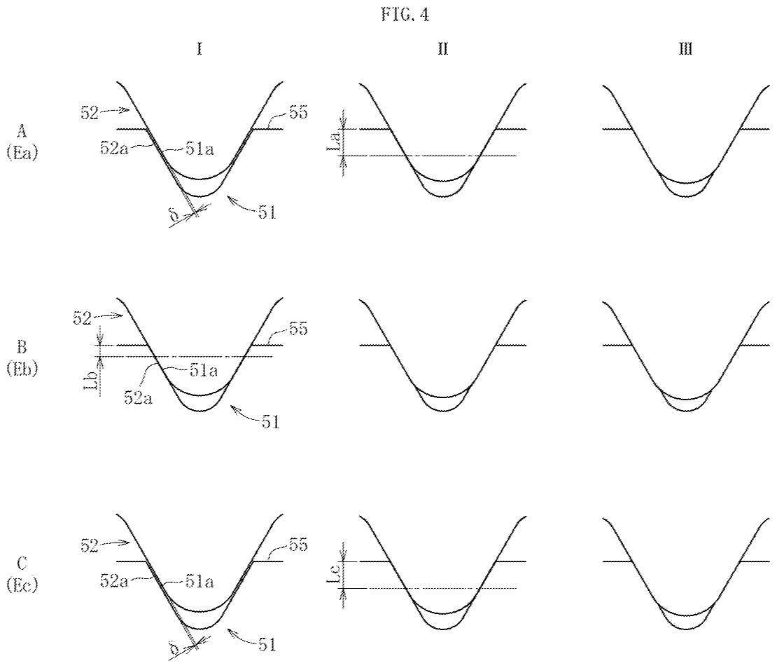

This will be specifically described with reference to FIG. 4. Note that rows I to III in FIG. 4 illustrate the meshing process of both the face splines 51 and 52 in time series, in which the row I illustrates the initial stage of the meshing, the row II illustrates the intermediate stage, and the row II illustrates the final stage. In FIG. 4, a line A illustrates the cross-sectional shape of the outer diameter portion Ea, a line B illustrates the cross-sectional shape of the intermediate portion Eb, and a line C illustrates the cross-sectional shape of the inner diameter portion Ec.

In the intermediate portion Eb (I-B) in the initial stage of the meshing process, a tooth surface 51a of the first face spline 51 and a tooth surface 52a of the second face spline 52 come into contact with each other, as illustrated in FIG. 4. At this time, in the outer diameter portion Ea (I-A) and the inner diameter portion Ec (I-C), there is a gap a between the tooth surfaces 51a and 52a. A depth from the tooth crest 55 to a portion of the tooth surface that first comes into contact with the mating tooth surface is referred to as a contact start depth. In FIG. 4, Lb indicates the contact start depth in the intermediate portion Eb.

When the meshing process proceeds to the intermediate stage (row II), the tooth surfaces 51a and 52a come into contact with each other also in the outer diameter portion Ea (II-A) and the inner diameter portion Ec (II-C). A contact start depth La in the outer diameter portion Ea and a contact start depth Lc in the inner diameter portion Ec are deeper than the contact start depth Lb in the intermediate portion Eb.

Thereafter, the meshing process further proceeds to the final stage (row II). Before the final stage (row III) is reached after the tooth surfaces 51a and 52a come into contact with each other, the tooth surfaces 51a and 52a are elastically deformed in any part of the outer diameter portion Ea, the intermediate portion Eb, and the inner diameter portion Ec, and the contact state between both the tooth surfaces 51a and 52a is maintained. At this time, the amounts of elastic deformation of the tooth surfaces 51a and 52b in the intermediate portion Eb, where they first come into contact with each other, are larger than the amounts of elastic deformation in the other portions (outer diameter portion Ea, inner diameter portion Eb).

It is preferable that, assuming that, in FIG. 3, the inner diameter end of the tooth crest 55 in the meshing region X is 0% and the outer diameter end is 100%, a region of 50% or more, specifically a region of 50 to 90%, is defined as the intermediate portion Eb where the tooth surfaces first come into contact with each other. When the region of 50% or more is defined as the intermediate portion Eb, a contact region Y (see FIG. 9B) between the tooth surfaces during torque transmission is generally formed on the outer diameter side, so that the load capacity at the time of torque transmission can be increased.

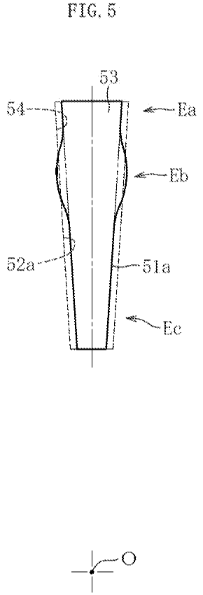

The contact order described above can be realized, for example, by determining the shape of the tooth surface 51a such that, in the intermediate portion Eb, the distance between the tooth surfaces (tooth width) of the ridges 53 of one of the face splines (e.g., the first face spline 51) is larger than the distance between the tooth surfaces with ideal contours (indicated by two-dot chain lines), as illustrated in FIG. 5. Although FIG. 5 illustrates the case where the recess 54 to mesh with the ridge 53 is formed with an ideal contour (indicated by broken line), a similar effect can also be realized by determining the shape of the tooth surface 52a such that, in the intermediate portion Eb, the distance between the tooth surfaces (width between the tooth gaps) of the recesses 54 of the other of the face splines (e.g., the second face spline 52) is smaller than the distance between the tooth surfaces with the ideal contours. In combination of them, the distance between the tooth surfaces of the ridges 53 may be increased in the intermediate portion Eb, and the distance between the tooth surfaces of the recesses 54 may be reduced. Here, the ideal contour means an ideal tooth profile contour without a machining error in which the tooth surfaces 51a and 52a of both the face splines 51 and 52 simultaneously come into contact with each other in the entire radial direction of the meshing region X.

In FIG. 5, the distance between the tooth surfaces in the intermediate portion Eb is exaggeratedly enlarged for easy understanding, but the actual amount of enlargement is an extent that exceeds a maximum machining error that can occur in the tooth surfaces 51a and 51b, and it is an extent that is difficult to distinguish with the naked eye. A reference sign O in FIG. 5 represents the rotation center of the wheel bearing device 1.

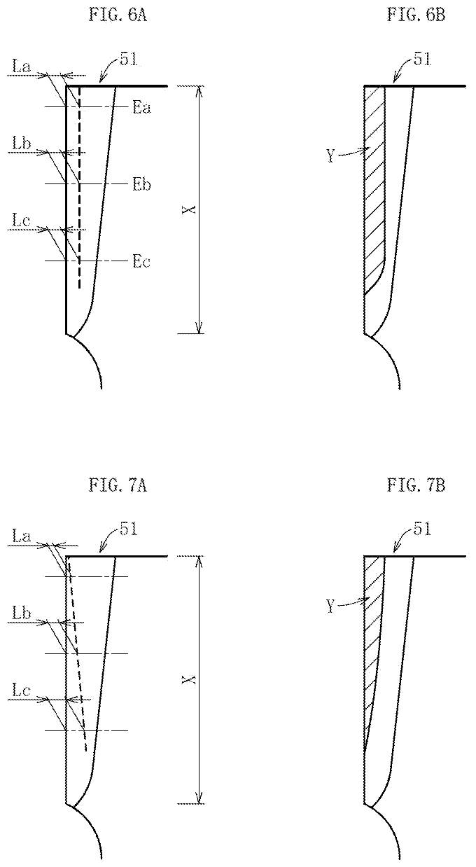

In FIG. 6A, the contact start depths La, Lb, and Lc between the tooth surfaces 51a and 52a, when the tooth surfaces of both the face splines 51 and 52 are formed with ideal contours, are indicated by broken lines. In this case, the tooth surfaces 51a and 52a simultaneously come into contact with each other in the entire radial direction of the meshing region X. and thus the contact start depths become a uniform depth in the radial direction. Therefore, the width of the contact region Y (indicated by hatching) between the tooth surfaces during torque transmission is constant without changing in the radial direction, as illustrated in FIG. 6B. On the other hand, a machining error is inevitable, and thus it is difficult to realize such a uniform contact start depth and a contact region having a uniform width.

FIGS. 7A and 7B illustrate the contact start depths La, Lb, and Lc and the contact region Y in a case where the tooth surfaces are brought into contact with each other from the outer diameter portion Ea, as described in Patent Literature 2. In this case, the contact region gradually expands toward the inner diameter side from where the outer diameter ends of the meshing region come into contact with each other, and thus, as illustrated in FIG. 7B, the contact region Y between the tooth surfaces 51a and 52a during torque transmission is wide on the outer diameter side and narrow on the inner diameter side. Therefore, when a bending moment is generated when the constant velocity universal joint 3 has the operating angle to transmit torque, the contact region Y on the outer diameter side disappears in a partial region (a mountain-folded region) in the circumferential direction of the torque transmission part 50, and the total area of the contact region Y greatly decreases, and thus the meshing between the tooth surfaces 51a and 52a is likely to be released. Therefore, the bending rigidity of the wheel bearing device 1 decreases.

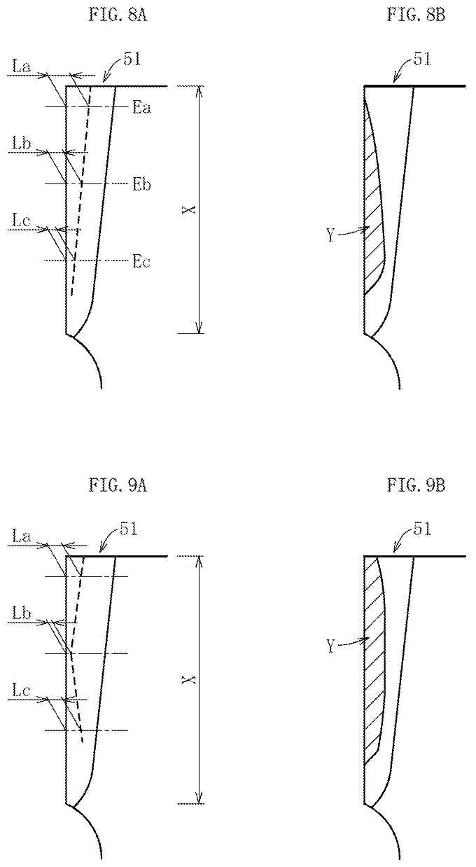

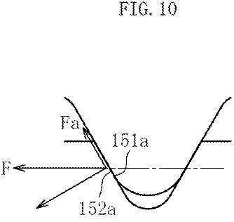

FIGS. 8A and 8B illustrate the contact start depths La, Lb, and Lc and the contact region Y in a case where the tooth surfaces are brought into contact with each other from the inner diameter portion Ec, as described in Patent Literature 3. In this case, the contact region gradually expands toward the outer diameter side from where the inner diameter ends of the meshing region come into contact with each other, and thus, as illustrated in FIG. 8B, the contact region Y between the tooth surfaces 51a and 52a during torque transmission is wide on the inner diameter side and narrow on the outer diameter side. In this case, the rotation radius of the contact region Y becomes small, and thus the load capacity at the time of torque transmission in the wheel bearing device 1 becomes insufficient.

FIGS. 9A and 9B illustrate the contact start depths La, Lb, and Lc and the contact region Y in a case where, as in the present embodiment, the tooth surfaces are brought into contact with each other from the intermediate portion Eb. In this case, the contact region gradually expands toward the outer diameter side and the inner diameter side from where the tooth surfaces in the intermediate portion Eb of the meshing region come into contact with each other. In this case, a wide region containing the intermediate portion Eb becomes the contact region Y during torque transmission. Therefore, even if a bending moment acts on the torque transmission part 5 when the constant velocity universal joint 3 has the operating angle to transmit torque, the total area of the contact region Y does not extremely decrease, so that the meshing between the tooth surfaces can be prevented from being released. In addition, the rotation radius of the contact region Y is generally increased, so that it is possible to sufficiently secure the load capacity at the time of torque transmission. Therefore, it is possible to provide the wheel bearing device 1 having high bending rigidity and a high load capacity at the time of torque transmission.

It is preferable to determine the shape of each of the tooth surfaces 51a and 52a such that, after the tooth surfaces in the intermediate portion Eb come into contact with each other, the tooth surfaces 51a and 52a come into contact with each other in the outer diameter portion Ea earlier than in the inner diameter portion Ec. As a result, the contact region Y during torque transmission expands in the radially outward direction, so that the load capacity at the time of torque transmission can be further increased.

The embodiments of the present invention are not limited to the above. Hereinafter, another embodiment of the present invention will be described, but redundant description of the same points as those in the above embodiment will be omitted.

In the embodiment described above, the second face spline 52 on the bearing 2 side is provided on the end surface of the fastening part 22 of the hub wheel 16, but in a case where the wheel bearing 2 without the fastening part 22 is used, the second face spline 52 can also be formed on the outboard-side end surface of the inner ring 17. In this case, it is desirable to provide a detent, such as a serration, between the inner ring 17 and the hub wheel 16 to couple them so as to be able to transmit torque.

In the embodiments described above, the case, where, as a mechanism for applying a tightening force in the axial direction between the hub wheel 16 and the outer joint member 31, the female screw part 38 is provided in the outer joint member 31 and a member (bolt member 26) having a male screw part to be screwed into the female screw part 38 is engaged with the hub wheel 16 in the axial direction, has been described as an example. However, the tightening force applying structure is arbitrary, and in addition to the above, for example, the male screw part 27 is provided in the outer joint member 31 and a member (e.g., a nut member) having a female screw part to be screwed with the male screw part is axially engaged with the hub wheel 16, whereby the tightening force can also be applied.

### REFERENCE SIGNS LIST

1 Wheel bearing device
2 Wheel bearing
3 Constant velocity universal joint
5, 6 Inner raceway surface
7 Inner member
10, 11 Outer raceway surface
12 Outer member
13 Rolling element
16 Hub wheel
17 Inner ring
18 Flange portion
26 Bolt member
31 Outer joint member
51 First face spline
51a Tooth surface
52 Second face spline
52a Tooth surface
Ea Outer diameter portion
Eb Intermediate portion
Ec Inner diameter portion

1. A wheel bearing device comprising:
a wheel bearing including an inner member having double row inner raceway surfaces and a flange portion for being attached to a wheel, an outer member having double row outer raceway surfaces, and a plurality of rolling elements disposed between the inner raceway surfaces and the outer raceway surfaces facing each other; and
a constant velocity universal joint having an outer joint member,
the outer joint member and the inner member being coupled so as to be able to transmit torque by meshing face splines respectively provided in the outer joint member and the inner member and applying a tightening force in an axial direction between both the face splines, wherein
shapes of tooth surfaces of both the face splines are determined such that, in a process of bringing both the face splines close to each other in the axial direction and meshing with each other, the tooth surfaces of both the face splines first come into contact with each other in, among an outer diameter portion of a meshing region between both the face splines, an inner diameter portion, and an intermediate portion sandwiched between the outer diameter portion and the inner diameter portion, the intermediate portion.

2. The wheel bearing device according to claim 1, wherein the shapes of the tooth surfaces of both the face splines are determined such that the tooth surfaces of both the face splines come into contact with each other in the outer diameter portion following the intermediate portion.

3. The wheel bearing device according to claim 1, wherein, assuming that, of the meshing region between both the face splines, an inner diameter end of a tooth crest of one of the face splines is 0% and an outer diameter end is 100%, a region of 50% to 90% is defined as the intermediate portion.
